(19) United States
(12) Patent Application Publication
(10) Pub. No.: US 2009/0052753 A1
(43) Pub. Date: Feb. 26, 2009

(54) IMAGE DISPLAY METHOD, IMAGE DISPLAY DEVICE AND IMAGE DISPLAY PROGRAM

(75) Inventor: Kazuhiko SUGAHARA, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/193,879

(22) Filed: Aug. 19, 2008

(30) Foreign Application Priority Data
Aug. 20, 2007 (JP) 2007-213315

(51) Int. Cl. G06K 9/00; G06K 9/36

(52) U.S. Cl. 382/128; 382/305

(57) ABSTRACT

A desired medical image is selected by access to a server from a client terminal. A dataset relating to the selected medical image is read out from the image server and transferred to the client terminal via a communication network. The dataset includes raw image data, compressed image data, partial image data and layout image data. At first, a compressed image is displayed on a monitor in the client terminal. Next, a partial image is fit in the compressed image based on the layout data. Finally, a raw image is displayed based on the raw image data.

### FIELD OF THE INVENTION

The present invention relates to a method, a device and a program for displaying an image obtained from a server.

### BACKGROUND OF THE INVENTION

In medical facilities, such as clinics and hospitals, a variety of modalities like CR (computed radiography), CT (computed tomography), MRI (magnetic resonance imaging), PET (positron emission tomography) have been widely used. The images captured by these modalities are utilized for medical diagnoses, and play an important role these days.

In these years, the medical images captured by these modalities are stored in a server, and doctors can browse the medical image(s) on a monitor of a client terminal that is LAN-connected to the server. If the client terminal is introduced in the doctor's office, a necessary medical image can be easily read when the doctor examines the patient(s).

Meanwhile, read-out of data in the server, data transfer using the LAN cable, expansion of compressed data at the client terminal are needed before display of the medical image on the monitor, and therefore some time lag occurs. Particularly, when medical images obtained by tomography such as the CT device and MRI device are displayed at the same time, time lag before displaying the medical images on the monitor is quite long. If a long time is taken between instruction of data display and display of the medical image, it is difficult to know whether a system functions well or not, and gives anxiety to the doctors operating the system. Moreover, the time before display of the image is a wait time that is a waste of time.

A prior art is known that reduced images whose data capacity is reduced by pixel skipping of raw images are prepared, and the reduced images are index-displayed to reduce length of the wait time (for example, JPA Hei10-243194).

However, since resolution of the reduced images is low, it is difficult to see a part of interest such as a diseased part in details. Therefore, if the doctors want to see the part of interest, they have to wait until display of the raw image. In this case, the wait time actually can not be reduced.

### SUMMARY OF THE INVENTION

An object of the invention is to provide a method, a device and a program for displaying an image which enable to reduce a wait time without lowering resolution of a part of interest.

In order to achieve the above and other objects, an image display device of the present invention includes a data read-out device for reading out a dataset stored in a server, a monitor for displaying an image based on data that is read out, and a monitor controller. The dataset includes raw image data, compressed image data which compresses the raw image to low resolution, partial image data, and layout data. At first, the monitor controller displays the compressed image on the monitor, and then displays the partial image on the monitor so as to overlap the compressed image based on the layout data, finally displays the raw image on the monitor, which is same display size as the compressed image.

The partial image is a partial image that is partially clipped of the raw image, or a partial image that is clipped of an image whose resolution is between the raw image data and the compressed image data, or a partial image that is partially clipped of the raw image and compressed to have higher resolution than the compressed image. The layout data shows a position, a size, and a scope of the partial image relative to the raw image.

In order to achieve the change of the partial image, it is desirable to provide an area setting device for setting the position, the size and the scope of the partial image relative to the original image displayed on the monitor. The partial image is generated by clipping a part of the raw image based on the position, the size, the scope which are set by the area setting device.

An image display method and program of the present invention include steps of reading out a dataset stored in a server, displaying an compressed image on a monitor, displaying a partial image based on a layout data so as to overlap the compressed image, and displaying a raw image on the monitor, which is same display size as the compressed image.

According to the present invention, after the compressed image for a low-resolution compressed image of the raw image is displayed, the partial image is displayed to overlap the compressed image, and the raw image that has the same display size as the compressed image is displayed, therefore time before display of the image can be reduced without lowering resolution of the part of interest.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic view illustrating a medical network system;

FIG. 2 is a block diagram illustrating an internal configuration of a client terminal;

FIG. 3 is a block diagram illustrating an internal configuration of an image server;

FIG. 4 is a schematic view illustrating a dataset;

FIG. 5A is a compressed image on a monitor, FIG. 5B is a partial image overlapping the compressed image and FIG. 5C is a raw image on the monitor;

FIG. 6A is a front view of a monitor showing an area setting button and FIG. 6B is a front view of an area setting screen for setting an extracting area;

FIG. 7 is a flowchart of a procedure before display of the medical image;

FIG. 8 is a schematic view illustrating a configuration of volume data obtained by tomography; and

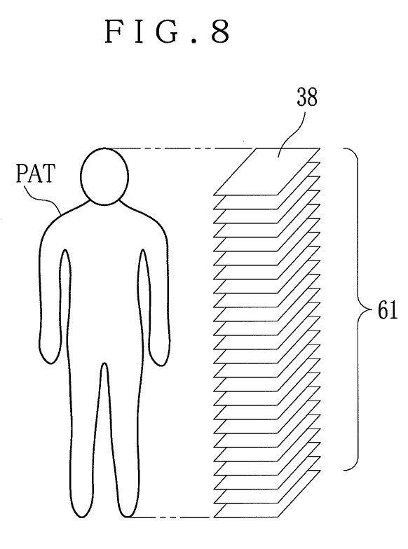

FIG. 9 is a flowchart illustrating a procedure for transfer of the plural medical images obtained by tomography.

### DESCRIPTION OF THE PREFERRED EMBODIMENTS

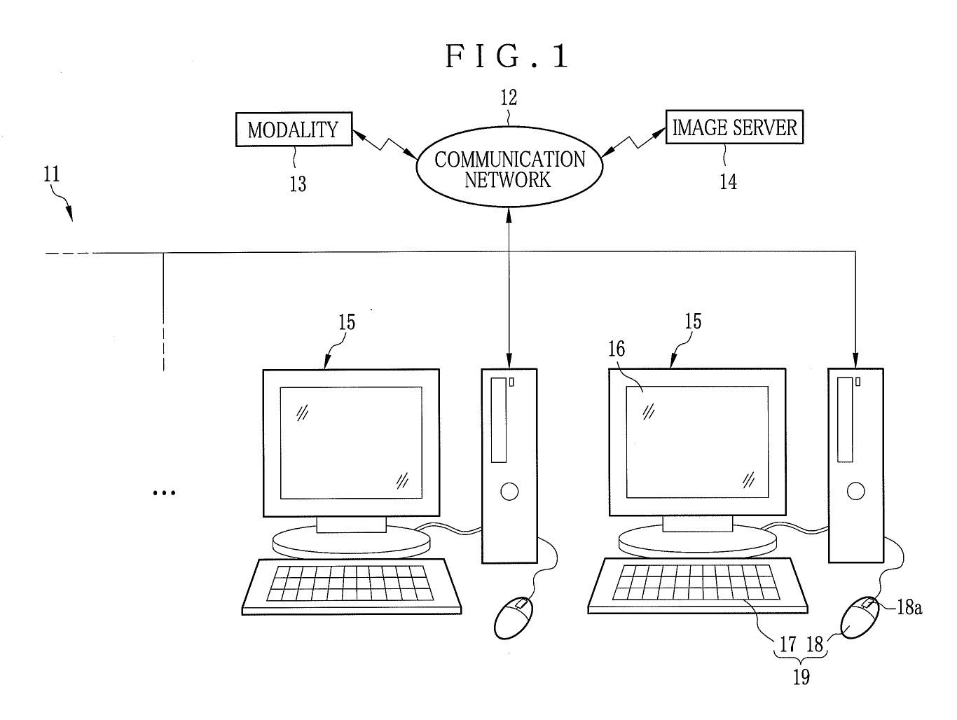

In a first embodiment shown in FIG. 1, a medical network system 11 includes a communication network 12 that enables data communication, a modality 13 for capturing medical image, a server 14 for storing the medical image, and plural client terminals 15 placed in clinics and used by doctors when they examine patients.

In the medical network system 11, various information and the medical image made in medical facilities are managed as electronic data to reduce a storage space for storing medical records and medical image films in the medical facilities. Additionally, the medical network system 11 allows easy read-out of the various information and the medical images on the client terminals 15, and improves the medical service in the medical facilities.

The communication network 12 is, for example, LAN (Local Area Network) placed in the medical facilities. The modality 13, the image server 14 and the client terminals 15 are connected to the communication network 12, and the communication network 12 provides data communication among them. The modality 13 captures medical image for various medical inspections. For the modality 13, various medical devices such as CR, CT, MRI, and PET are used.

The client terminal 15 is for example, a well known personal computer or a work station, which includes a monitor 16 and an operating section 19. The monitor 16 displays various operation screens and images. The operating section 19 includes a keyboard 17 and a mouse 18 for entering an operation signal. A wheel 18a is rotatably attached to the mouse 18. Rotating operation of the wheel 18a allows entering an operation signal such as a display changing signal. The client terminal 15 runs an image display program, and functions as the image display device of the present invention, which reads out the medical image stored in the image server and displays it on the monitor 16.

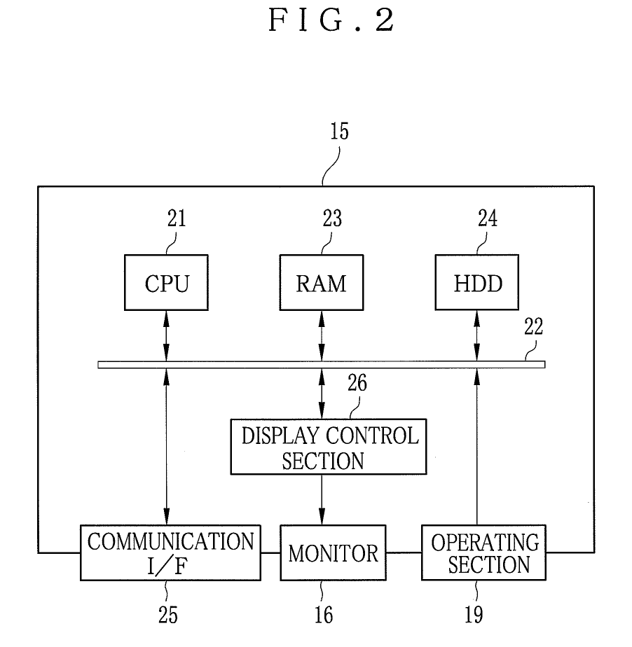

As shown in FIG. 2, the client terminal 15 has a CPU 21. The CPU 21 entirely controls the client terminal 15 according to an operation signal that is input from the operating section 19. A RAM 23, a hard disc drive (HDD) 24, a communication interface (communication I/F) 25 and a display control section 26 in addition to the operating section 19, are connected to the CPU 21 via a data bus 22.

The Ram 23 is a working memory for the CPU 21 to execute a process, and temporally stores the medical image that is read out from the image server 14.

In the HDD 24, various programs (including an image display program and data) for actuating the client terminal 15 are stored. The CPU 21 reads out the program from the HDD 24, expands the program to the RAM 23 and successively runs the program. The CPU (read-out device) 21 actuates each part of the client terminal 15 and reads out the medical image from the image server 14 according to the operation signal that is input from the operating section 19.

The communication I/F 25 is, for example a modem or a router, which appropriately controls communication protocol for the communication network 12, and exchanges the data that passes through the communication network 12. Data obtained through the communication I/F 25 is temporally stored in the RAM 23. The display control section 26 controls display of the monitor 16 to display, for example, the medical image that is read out from the image server 14.

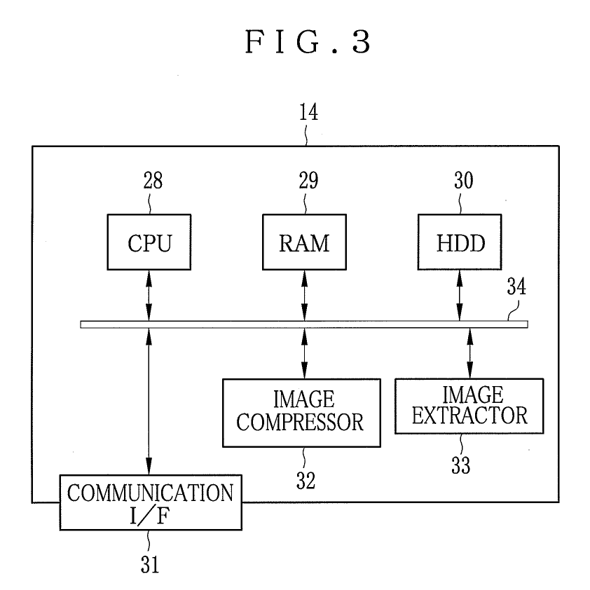

The image server 14 is so called a PACS (Picture Archiving and Communication System for medical application) server. As shown in FIG. 3, the image server 14 includes a CPU 28, a RAM 29, a hard disc drive (HDD) 30, a communication interface (communication I/F) 31, an image compressor 32 and an image extractor 33. They are connected to each other via a data bus 34.

Various programs and data for actuating the image server 14 are stored in the HDD 30. The CPU 28 reads out each program from the HDD 30, expands the program to the RAM 29 and successively runs the program to entirely control the image server 14. The communication I/F 31 is identical to the communication I/F 25 provided in the client terminal 15, so detailed description is omitted.

Medical image transferred from the modality 13 is stored in the HDD 30. Medical image stored in the HDD 30 includes a referential image and an illustrated image which are used for, for example contrasting symptoms when doctors give a diagnosis or explain to the patients, in addition to the image captured by the modality 13.

The image compressor 32 performs compression process to the image data such as the medical image when the image data is input. The compression process is a process of reducing data capacity by compressing the data to low resolution while maintaining the frames size. The image extractor 33 performs extracting process to the image data when the image data is input. The extracting process is a process of extracting an area of predetermined position, size and scope.

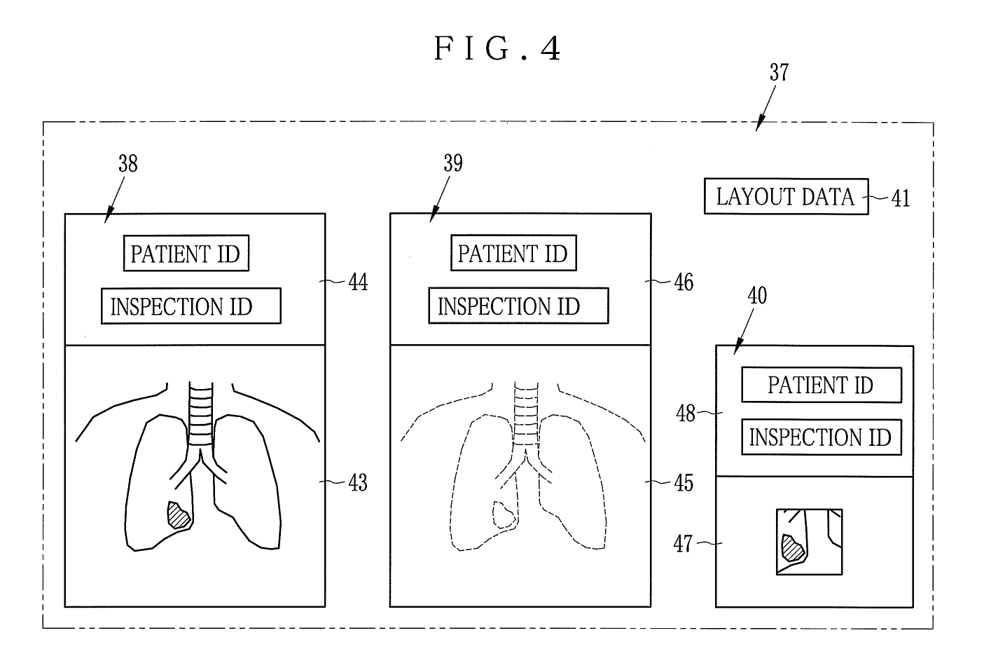

Medical image transferred from the modality 13 to the image server 14 is stored in the HDD 30 in a state of a dataset 37 as shown in FIG. 4. The dataset 37 includes raw image data 38, compressed image data 39, partial image data 40 and layout data 41. The raw image data 38 is uncompressed image data (so called a raw data) that is output from the modality 13. The compressed image data 39 is image data generated by performing compression process to the raw image data. The partial image data 40 is image data generated by performing extracting process to the raw image data. The layout data 41 is information showing the position, the size and the scope of the area that is extracted as the partial image data 40.

When the raw image data 38 is sent from the modality 13 via the communication I/F 31, the CPU 28 of the image server 14 inputs the raw image data 38 to the image compressor 32 and the image extractor 33. Receiving the raw image data 38 from the CPU 28, the image compressor 32 generates the compressed image data 39 from the raw image data 38 and sends the compressed image data 39 to the CPU 28. Receiving the raw image data 38 from the CPU 28, the image extractor 33 generates the partial image data 40 from the raw image data 38, and sends the partial image data 40 and the layout data 41 to the CPU 28. Receiving the compressed image data 39, the partial image data 40 and the layout data 41, the CPU 28 records these data and the raw image data 38 in the HDD 30 as the dataset 37. Accordingly, each medical image is managed in a state of the dataset 37 in the image server 14.

The raw image data 38 includes an image recording area 43 for recording image data and a tag area 44 for recording metadata. In the tag area 44, for example, a patient ID and an inspection ID are recorded as metadata. It is noted that the patient ID is an inherent number given to each patient. Additionally, the inspection ID is an inherent number given to each inspection (captured by the modality 13). The patient ID and the inspection ID recorded in the tag area 44 are related to the dataset and used for, for example, searching the raw image data 38.

The compressed image data 39 and the partial image data 40 respectively have image recording areas 45 and 47, and tag areas 46 and 48 in similar to the raw image data 38. The patient ID and the inspection ID are recorded as metadata in each of the tag areas 46 and 48. It is noted that the layout data 41 is associated with the partial image data 40 by a file name or the like. Moreover, the layout data 41 may be recorded in the tag area 48 as metadata of the partial image data 40.

Doctors working at each clinic access to the image server 14 via the client terminal 15 and displays medical image on the monitor 16 when the doctors give a diagnosis or explain the symptoms to the patients. Request for read-out of medical image is done by selecting a desired inspection from a not-shown inspection list or the like. When read-out of the medical image is requested from the client terminal 15, the CPU 28 of the image server 14 searches the HDD 30 based on the patient ID and inspection ID of the selected inspection, and reads out the medical image in a unit of the dataset 37. Then, the CPU 28 transfers the medical image to the client terminal 15 where the read-out of the medical image was requested.

The medical image is expanded on a data-to-data basis in the client terminal 15, and display of the medical image on the monitor 16 can be allowed. The time required before image display on the monitor 16 are time for read-out of data in the image server 14, time for data transfer via the communication network 12 and time for data expansion in the client terminal 15 are required, an it changes depending on the data capacity of the image to be displayed. The data capacity increases in the following order, the partial image data 40, the compressed image data 39 and the raw image data 38. That is, time before display is longer in the following order, the partial image data 40 having small capacity, the compressed image data 39 and the raw image data 38.

Consequently, before display of the raw image 52 on the monitor 16 based on the raw image data 38, a compressed image 50 is displayed on the monitor 16 based on the compressed image data 39, and then a partial image 51 is displayed to overlap the compressed image 50 based on the partial image data 40.

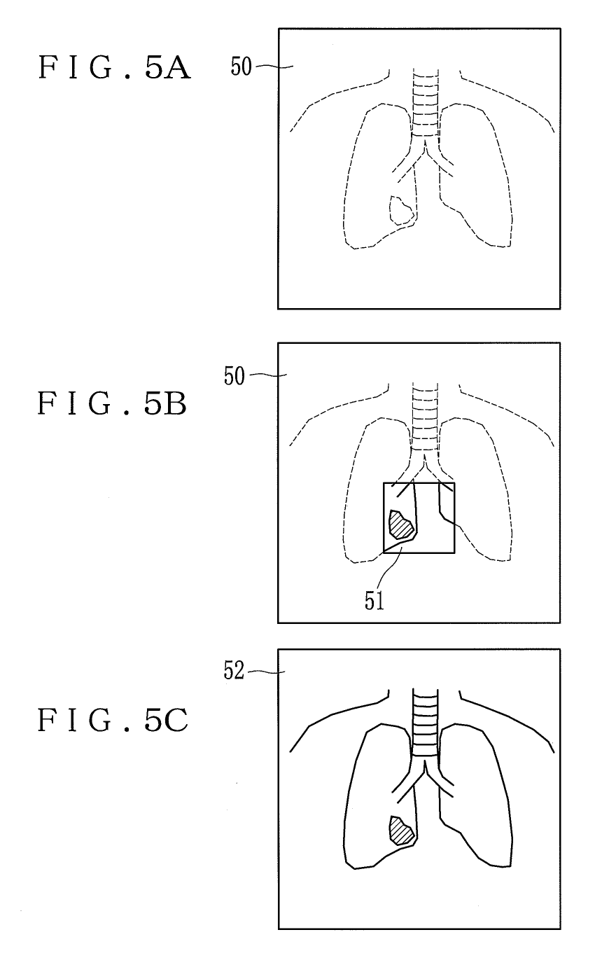

As shown in FIG. 5A, for example, the compressed image 50 is displayed on the monitor 16 based on the compressed image data 39 after 0.5 seconds from a request of read-out of the medical image. Shortly thereafter (for example, 0.005 seconds later), as shown in FIG. 5B, the partial image 51 is displayed to overlap the compressed image 50 based on the partial image data 40 and the layout data 41. Further 2 seconds later, as shown in FIG. 5C, the raw image 52 is displayed based on the raw image data 38. It is noted that a borderline around the partial image 51 is illustrated in FIG. 5B, but it does not exist actually.

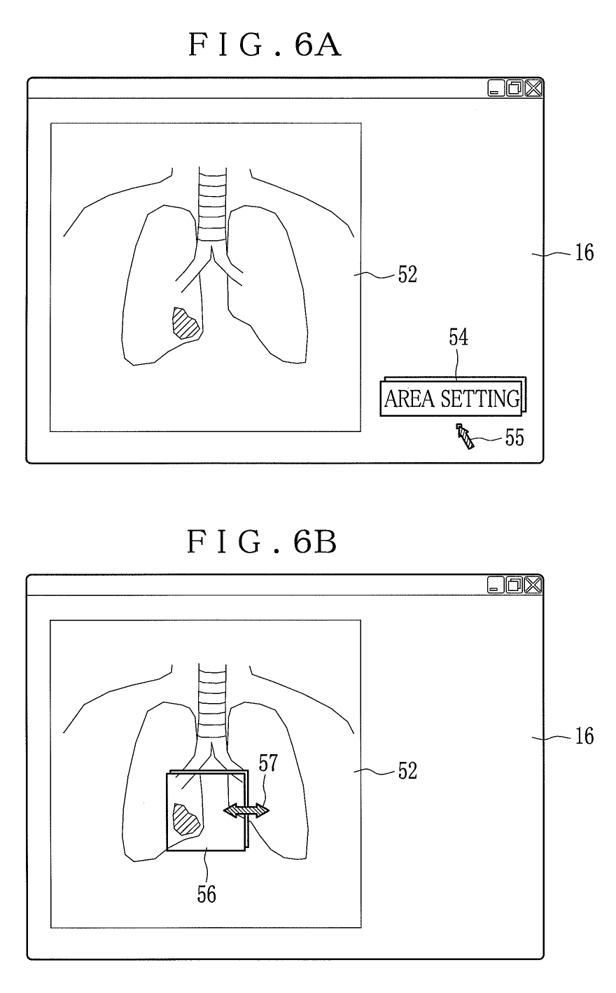

As shown in FIG. 6A, a setting button 54 and a cursor 55 are displayed on the monitor 16 displaying the raw image 52. The setting button 54 is a button for shifting to an area setting screen to set and change selected position, size and scope of the partial image, and selected by the cursor 55. The cursor 55 moves in the monitor 16 according to the operation signal that is input from the operating section 19. When the cursor 55 is moved to the setting button 54, and selection operation is done, the screen is shifted to the area setting screen.

As shown in FIG. 6B, a frame 56 and a cursor 57 are displayed on the area setting screen. In the default state, the frame 56 shows the poison, size and scope of the partial image 51 (see FIG. 5B), and the position, size and scope are changeable by operation of the cursor 57. The cursor 57 moves in the screen of the monitor 16 according to the operation signal that is input from the operating section 19. When the position, size and scope of the frame 56 are changed and confirmed, changing information about the position, the size and the scope of the partial image is input to the image server 14.

When the changing information is sent from the client terminal 15, the CPU 28 of the image server 14 reads out the raw image 38 from the HDD 30 and transfers it to the image extractor 33 along with the changing information. Receiving the raw image data 38 from the CPU 28, the image extractor 33 performs the extracting process based on the changing information, and generates a new partial image data. The generated partial image data is transferred to the HDD 30 along with the layout data, and the partial image data and its layout data stored as the dataset 37 are overwritten.

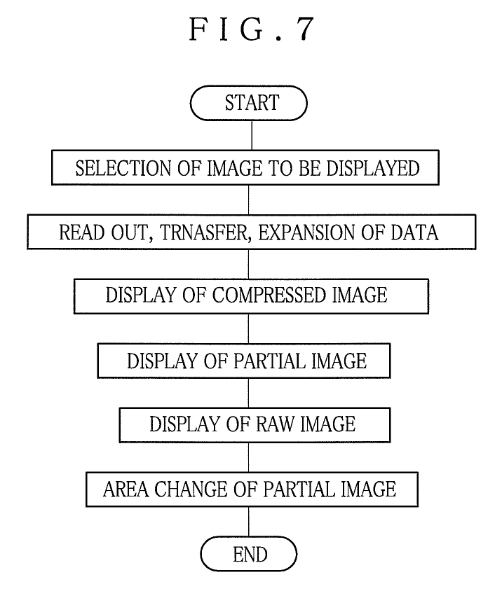

Operation of the first embodiment will be explained with reference to FIG. 7. When the medical image stored in the HDD 30 of the image server 14 is displayed on the monitor 16 of the client terminal 15, a doctor operates the operating section 19 and selects a medical image to be displayed. The dataset 37 of the selected medical image having the raw image data 38, the compressed image data 39, the partial image data 40 and the layout data 41 (see FIG. 4) are read out from the image server 14, and sent to the client terminal 15 via the communication network 12.

The raw image data 38, the compressed image data 39, the partial image data 40 which are transferred to the client terminal 15 are displayed on the monitor 16 in a predetermined order. At first, the compressed image 50, shown in FIG. 5A, is displayed based on the compressed image data 39. Next, the partial image 51 is displayed, based on the partial image data 40 and the layout data 41, to overlap with the compressed image 50, as shown in FIG. 5B. Further, the raw image 52 is displayed based on the raw image data 38, as shown in FIG. 5C.

In this manner, since the compressed image 50 is displayed in the time between operation of the operating section 19 and display of the raw image 52, time lag can be reduced. The partial image 51 is displayed in a short time following the display of the compressed image 50. If the partial image 51 is the part of interest such as a diseased part, detailed reading can be performed in a short time from the operation of the operating section 19.

When the setting button 54 (see FIG. 6A) is selected, the screen is shifted to the area setting screen (see FIG. 6B) to change the position, size and scope of the partial image. In the area setting screen, the position, the size and the scope of the frame 56 are changed to the part of interest such as the diseased part by operation of the cursor 57. Then, changing information about the position, the size and the scope of the partial image is input to the image server 14 by enter operation.

When changing information is sent from the client terminal 15, in the image server 14, the raw image data 38 is read out from the HDD 30 and transferred to the image extractor 33 along with the changing information. In the image extractor 33, the extracting process is performed based on the changing information to generate a new partial image. The generated partial image data is sent to the HDD 30 along with the layout data, and the partial image and its layout image stored as the dataset 37 are overwritten.

In the first embodiment, one medical image is selected and displayed on the monitor 16, but several medical images may be selected and displayed on the monitor 16 as shown in a following second embodiment, so as to switch over the several medical images on the monitor.

The medical network system 11 of the second embodiment has the same structure as that of the first embodiment, so detailed explanation is omitted. The modality 13 continuously captures cross section (tomography) of a patient (PAT) and obtains plural successive medical images. The raw image data 38 relating to the medical images obtained by the tomography session makes up a volume data 61.

The plural medical images composing the volume data 61 are transferred to the image server 14 from the modality 13 and respectively stored in the HDD 30 in a state of the dataset 37 as shown in FIG. 4. These medical images are given an identical inspection ID, which is recorded in the tag areas 44, 46 and 48 of the raw image data 38, the compressed image data 39 and the partial image data 40 and shows that these medical images are obtained by the same tomography session.

When the read-out of a medical image is requested from the client terminal 15, the CPU 28 of the image server 14 searches the HDD 30 based on the patient ID and the inspection ID of the selected inspection. If the requested medical image was obtained by tomography session, the CPU 28 reads out the compressed image data 39, the partial image data 40 and the layout data 41 of the searched plural medical images in the order they were captured by the modality 13, and transfers them to the client terminal 15. Then, the CPU 28 reads out the raw image data 38 of the searched plural medical images in the order they were captured by the modality 13, and transfers them to the client terminal 15.

The compressed image, the partial image and the raw image for the first captured medical image by the modality 13, among the plural medical images transferred to the client terminal 15, are sequentially displayed on the monitor 16 based on the prepared image data.

The wheel 18a of the mouse 18 outputs the operation signal by its rotating operation to switch the medical images displayed on the monitor 16.

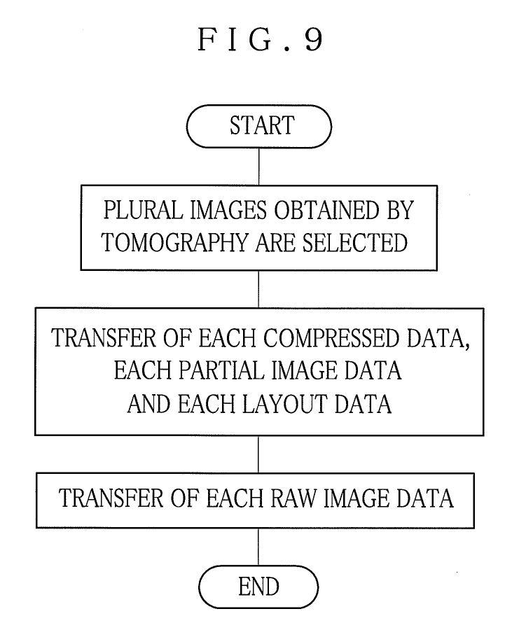

Operation of the second embodiment will be explained with reference to FIG. 9. When a doctor operates the operating section 19 and selects plural medical images obtained by the tomography, each of the selected medical images is searched. About each of the searched medical images, the compressed image data 39, the partial image data 40 and the layout data 41 are read out in the order they were captured by the modality 13, and transferred to the client terminal 15 via the communication network 12.

Further, about each of the searched medical images, the raw image data 38 is read out in the order they were captured by the modality 13 and transferred to the client terminal 15 via the communication network 12.

The image of the first captured medical image by the modality 13, among the plural medical images transferred to the client terminal 15, are displayed on the monitor 16 in a predetermined order. This display is similar to the above FIG. 5A to 5C.

When the wheel 18a rotates by operation of the mouse 18, the medical image displayed on the monitor 16 is switched. If the second raw image data 38 has already been transferred, the raw image 52 shown in FIG. 5C is displayed on the monitor 16 based on the raw image data 38 immediately after operation of the wheel 18a of the mouse 18.

Meanwhile, if the second raw image data 38 has not been transferred, the compressed image 50 shown in FIG. 5A is displayed on the monitor 16 based on the compressed image data 39 after the operation of the wheel 18a of the mouse 18. The partial image 51 is then displayed to overlap the compressed image 50 based on the partial image data 40 and the layout data 41 as shown in FIG. 5B. Further, when the raw image data 38 is transferred and preparation for display is done, the raw image 52 is displayed based on the raw image data 38, as shown in FIG. 5C.

Even when the time lag between the operation on/of the operating section 19 and the display on the monitor 16 accumulates because of switching and displaying the plural medical images, the compressed image 50 is displayed in a short time, so time lag can be reduced. The partial image 51 is displayed in a short time following the display of the compressed image 50. If the partial image 51 is the part of interest such as a diseased part, detailed reading can be allowed in a short time from the operation of the operating section 19.

In the above embodiments, one medical image is displayed on the monitor 16 of the client terminal 15, but plural medical images may be displayed. In this case, since the time before display of the images accumulates according to the number of the medical images, the wait time for displaying all of the raw images 52 becomes longer with increase of the number of the images to be displayed. However, since the compressed image 50 and the partial image 51 corresponding to each of the raw images 52 can be displayed before display of the raw image 52, non-display time can be reduced. Moreover, detailed reading can be allowed in a short time from operation of the operating section 19. Thus, result of the present invention is notably visible according to increase of the number of the images displayed simultaneously.

In the above embodiments, the raw image data 38 to which imagining process is not performed is transferred to lastly to display the raw image on the monitor 16, but it may be possible to apply a lossless compression to the raw image data and then decompresses the data in the client terminal 15 to display the raw image on the monitor 16 lastly. It is noted that the lossless compression means compression for reducing data size by compression of data under recoverable condition. The lossless compression is a well known art, so the detailed description is omitted.

In the above embodiments, the partial image 51 is a part of the raw image 52 (the partial image 51 has same resolution as the raw image), but the partial image 51 need only have high resolution than the compressed image 50. For example, the partial image 51 may be a compressed part of the raw image 52 with higher resolution than the compressed image 50.

In the above embodiments, when the position, the size and the scope of the partial image are changed, the partial image data and its layout data are overwritten by new data, but the new data may be added without destroying the old data. Further, in place of generating the raw image to be stored in the server in advance, the partial image may be generated by reading out the partial image data from the raw image data based on the layout data when the partial image is sent to the client terminal.

In the above embodiments, one partial image is made for one raw image, but plural partial images may be generated from one raw image. In this case, the plural partial images may be different parts of the raw image or may be the same parts of the raw image having different resolution each other.

Moreover, in the second embodiment, when the raw image data 38 of the plural medical images is transferred, the data of the raw image whose compressed image 50 and the partial image 51 are being displayed may be transferred first.

Various changes and modifications are possible in the present invention and may be understood to be within the present invention.

What is claimed is:

1. An image display device comprising:
a data read-out device for reading out a dataset stored in a server, said dataset including raw image data, compressed image data for a low-resolution compressed image of said raw image, partial image data, and layout data, said partial image data being a part of said raw image and having higher resolution than said compressed image, said layout data showing a position, a size and a scope of said partial image relative to said raw image; and
a monitor controller for controlling a monitor, said monitor controller firstly displaying said compressed image on said monitor, then displaying said partial image to overlap said compressed image based on said layout data, and lastly displaying said raw image in the same display size as said compressed image on said monitor.

2. An image display device described in claim 1, wherein said partial image is generated by clipping a part of said raw image.

3. An image display device described in claim 1, further including an area setting device for setting a position, a size and a scope of said partial image relative to said raw image, said server generating said partial image by clipping a part of said raw image based on said position, said size and said scope.

4. An image display method comprising the steps of:
reading out a dataset stored in a server, said dataset including raw image data, compressed image data for a low-resolution compressed image of said raw image, partial image data, and layout data, said partial image being a part of said raw image and having higher resolution than said compressed image, said layout data showing a position, a size and a scope of said partial image relative to said raw image; and
displaying said compressed image on a monitor;
displaying said partial image to overlap said compressed image on said monitor based on said layout data; and
displaying said raw image on said monitor in the same display size as said compressed image.

5. An image display method described in claim 4, wherein said partial image is generated by clipping a part of said raw image.

6. An image display method described in claim 4, further comprising the steps of:
setting a position, a size and an scope of said partial image relative to said raw image; and
generating said partial image by clipping a part of said raw image based on said position, said size and said scope.

7. An image display program run by a computer comprising the steps of;
reading out a dataset stored in a server, said dataset including raw image data, compressed image data for a low-resolution compressed image of said raw image, partial image data, and layout data, said partial image being a part of said raw image and having higher resolution than said compressed image, said layout data showing a position, a size and a scope of said partial image relative to said raw image;
displaying said compressed image on a monitor;
displaying said partial image so as to overlap said compressed image on a monitor based on said layout data; and
displaying said raw image in the same size as said compressed image on said monitor.

8. An image display program described in claim 7, wherein said partial image is generated by clipping a part of said raw image.

9. An image display program described in claim 7, further comprising the steps of:
setting a position, a size and a scope of said partial image relative to said raw image; and
generating said partial image by clipping a part of said raw image based on said position, said size and said scope.
